(19) United States
(12) Patent Application Publication
(10) Pub. No.: US 2012/0170907 A1
(43) Pub. Date: Jul. 5, 2012

(54) SYSTEM AND METHOD FOR STREAMING CONTENT TO BLU-RAY DEVICES

(76) Inventors: Mark Johnson, Pasadena, CA (US); Kuyen Tsao, Pasadena, CA (US); Darren Lepke, San Francisco, CA (US)

(21) Appl. No.: 13/344,579

(22) Filed: Jan. 5, 2012

Related U.S. Application Data
(60) Provisional application No. 61/430,169, filed on Jan. 5, 2011.

(51) Int. Cl. H04N 9/80; H04N 5/93

(52) U.S. Cl. 386/241; 386/353; 386/E09.011; 386/E05.028

(57) ABSTRACT

A standard Clip Information (“CLPI”) file is pre-defined for use in a Blu-ray environment. The CLPI file is structured to specify a set of parameters that are determined independent of any particular content segment. A content segment is structured to conform to the standard CLPI file, including to the set of parameters. The standard CLPI file is used to stream the content segment to the Blu-ray player.

### RELATED APPLICATIONS

This application claims benefit of priority to Provisional U.S. Patent Application No. 61/430,169, filed Jan. 5, 2011; the aforementioned priority application being hereby incorporated by reference in its entirety.

### TECHNICAL FIELD

Embodiments described herein pertain to a system and method for streaming content to media playback devices.

### BACKGROUND

Blu-ray Disc technology includes standards and data formats implemented by the Blu-ray Disc Association. As noted in this application, numerous documentation exists that define the standards and requirements employed by the Blu-ray Disc Association. By way of illustration, the document entitled “Application Definition Blu-ray Disc Format,” published by the Blu-ray Disc Association in March 2005, provides descriptions of various elements in the Blu-ray format. In particular, the Blu-ray Prerecorded application format (BD-ROM) is known to include four layers for managing streaming files: Index table, Movie Object/BD-J Object, PlayList and Clip. The “Index Table” is a top-level table that defines the titles and the top menu of a BD-ROM disc. This table includes entry points for all of the titles, and the Blu-ray player references the table whenever a title or menu is being executed. The “Movie Object” consists of an executable navigation command program. A Clip is a stream file, and the collection of playing intervals in the Clips is referred to as the PlayList.

With regard to the Clip, it includes (i) A Clip AV stream file stored an contained in a structure compliant with the BD-ROM specification, and (ii) a Clip Information File, which stores time stamps of the access position in the corresponding stream file. In general, the player reads the information from the Clip Information File in order to determine where it should begin to read the data from the corresponding stream file.

### BRIEF DESCRIPTION OF THE DRAWINGS

FIG. 1 illustrates a process for streaming content to Blu-ray devices, according to embodiments.

FIG. 2 illustrates a process for varying the bit-rate of playback on a Blu-ray player for content originating from a network, according to an embodiment.

FIG. 3 is a block diagram that illustrates a computer system upon which embodiments such as described may be implemented.

### DETAILED DESCRIPTION

Embodiments described herein provide for streaming content to media playback devices, such as Blu-ray devices.

According to some embodiments, a “Clip Information File” (or “CLPI file”) is pre-defined for use with content segments that are streamed to a Blu-ray player. In particular, the CLPI file is structured independently of any particular content segment. According to an embodiment, the pre-defined CLPI file specifies a set of parameters for individual content segments that comprise a content work or playlist. In contrast to conventional approaches, a content work or playlist is structured into a plurality of content segments (e.g., Clip AV stream file) that individually conform to the set of parameters of the pre-defined CLPI file. The content is then streamed to the media playback device (e.g., device capable of playing back Blu-ray or Blu-ray Disc optical format).

Embodiments described herein provide a system and method for streaming content to a Blu-ray player. In an embodiment, a standard CLPI file is generated. The CLPI file is structured to specify a set of parameters that are determined independent of any particular playlist or content work (e.g., movie title). Individual content segments that comprise a work or playlist are structured to conform to a standard CLPI file, including to the set of parameters. The standard CLPI file is used to stream the content segment to the Blu-ray player.

Still further, embodiments provide for a standard CLPI file to be associated with multiple different content playlists and works (e.g., movie titles), for use in playing back the content segments in a Blu-ray environment. For example, a standard CLPI file may be associated with content segments that comprise a single content work (e.g., movie title), multiple content works (e.g., movie titles) or to different content segments of different data qualities, representing a same unit of content (e.g., a same amount of time in a movie).

As used herein, the term “same” in the context of a file or data (e.g., CLPI file) means substantially duplicate or a copy.

Still further, some embodiments provide for a method of operating a Blu-ray player. In an embodiment, streaming content is received from over a network and played back at a first quality. While the streaming content is played back, the Blue-ray player determines information about an amount of data that can be received from the network or otherwise processed by the Blu-ray player. Based on the determined information, the Blu-ray player communicates with the network service to receive and playback the streaming content at a second quality level.

Among other benefits, embodiments recognize that streaming data to media playback devices, such as those that incorporate Blu-ray players, is under conventional approaches, heavy with technological overhead. For example, in connection with the playback of a given clip, the CLPI file associated with individual content items can only be installed once, and the Blu-ray player will typically soft-reboot (with a virtual file system (“VFS”) update) when a new CLPI file is used. The result is that under conventional approaches, content playback in the Blu-ray environment does not provide for swapping clips of video segments. Even though the Blu-ray player can playback content originating from a network source, the limitations relating to CLPI files preclude clip swapping or variations, at least to an extent that maintains a good user experience.

In contrast, some embodiments described herein enable the use of a standard CLPI file (or set of standard CLPI files) that enables the network streaming content to be structured or conformed to a standard CLPI file in use of on the Blu-ray player so as to avoid reboot from the Blu-ray player.

Still further, an embodiment provides for Blu-ray Discs to encode content (e.g., movie title) using a standard CLPI file. When loaded into the Blu-ray player, the Blu-ray player can be controlled in accessing streaming content (e.g., trailers, director cut scenes etc.) from a network service. According to an embodiment, the network content can be processed using the same CLPI file as used in rendering the local content from the Blu-ray Disc. This allows the Blu-ray player to render both local and network content concurrently, using a same CLPI file.

In variations, the Blu-ray player can be controlled in acquiring a CLPI file for use in playing back a local content (e.g., from Blu-ray Disc) and for receiving network content concurrently with playing back the local content. In one implementation, the Blu-ray player can identify the local media to a network service by identifier, then receive a CLPI file from the network service for use in playing back the local content and/or additional network content.

As used herein, BD refers to Blu-ray Disc®, and BD specification refers to the various documents that define the behavior and requirements of BD players, software and related systems, and, in particular, “System Description Blu-ray Disc Read-Only Format: Part 3. Audio Visual Basic Specifications”. The BD specification includes a section pertaining to VFS updates.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

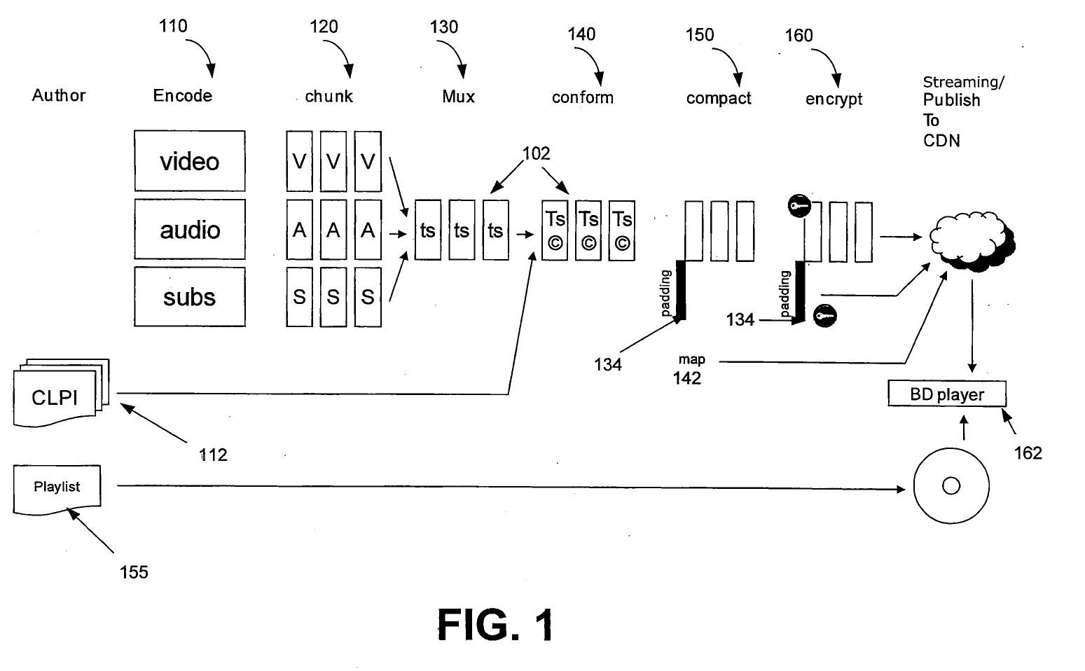

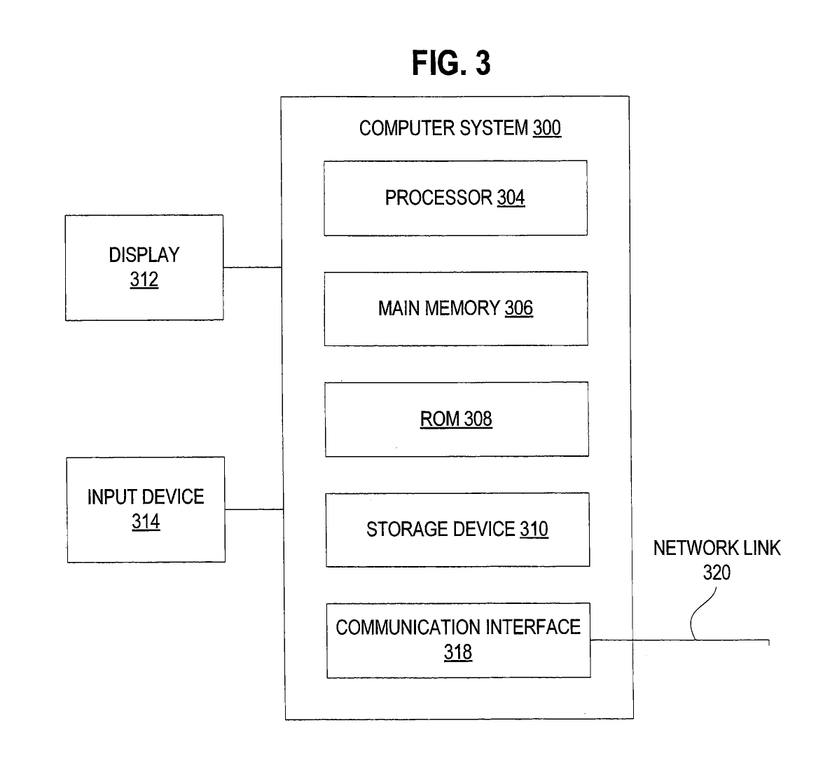

FIG. 1 illustrates a process for streaming content to Blu-ray players, according to embodiments. An embodiment such as described with FIG. 1 may be implemented in whole or in part on a server, or a combination of servers that combine to provide a service for Blu-ray players and Blu-ray enabled devices. Still further, a process such as described by FIG. 1 may be implemented through use of hardware, software and logic such as described with an embodiment of FIG. 3.

Embodiments recognize that streaming content to Blu-ray players (e.g. standalone Blu-ray device) can serve a variety of purposes. Among the purposes, the Blu-ray player can augment or supplement playback of Blu-ray content provided from a Blu-ray disc (local source) with content that originates from a network site or Internet Protocol enabled application server. In this way, the network content can augment or supplement the user experience rendered through the local Blu-ray disc media. For example, the network site can be used for promotions (e.g. movie trailers), displaying additional content (e.g. director cut scenes), or providing the entire Blu-ray content (e.g. replacement movie for seed Blu-ray disc, additional catalog movies, related television shows, bonus material or other archival content). Numerous other variations are possible, including streaming content which are produced as the result of a broadcast video content encoding, such as live television, as well as streaming content from a (personal or professional) video camera or other live video source.

According to embodiments, a process includes encoding content having video and audio, as well as optionally, other aspects such as subtitles. In one embodiment, content is re-encoded from a standard Blu-ray encoding scheme into one which utilizes smaller time segments (e.g. 10 seconds). The encoding process includes chunking the data, and then performing a multiplexing (or “muxing”) process 130 where the data is muxed into content segments 110 of appropriate length of time. The content segments 110 are further structured to include characteristics such as iframes, with defined lengths of time. In implementation, each content segment 110 can correspond to a Clip AV stream file, which can be played back using an associated CLPI file 112 (discussed in greater detail below).

Additionally, one source of content may be encoded for multiple resolutions, to enable streaming across multiple network bandwidths. Thus, for example, one movie title may be separately encoded for Blu-ray players and output devices that handle different levels of resolution.

As described, embodiments include use of a standard CLPI file, which is structured independent of any specific content segment, content work or playlist. One or more such standard CLPI files can be used to manage corresponding content segments generated from the encoding process shown in FIG. 1. The use of independent or standard CLPI files specify a same or common set of CLPI parameters or characteristics.

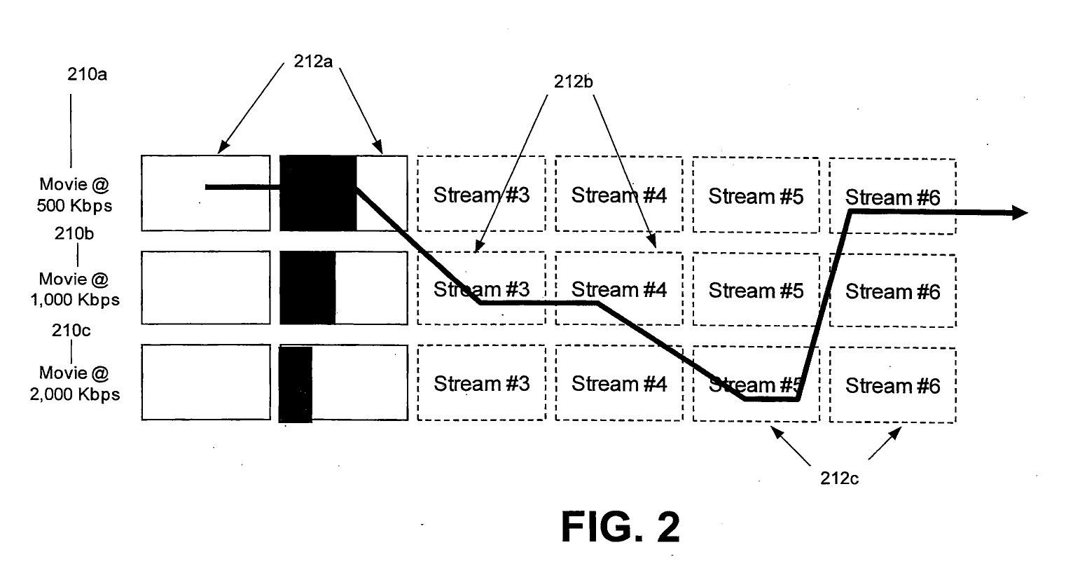

In an embodiment, a set of one or more CLPI files 112 are generated for use with content segments 102, where each of the CLPI files 112 are pre-defined to specify set of characteristics that are independent of any particular content work or playlist. In a pre-defined standard CLPI file, parameters such as the start/end time control the Blu-ray player in determining the start/end times of the associated content segment (e.g., associated Clip AV stream file), but unlike conventional approaches, the parameters of the CLPI file are specified independently of the associated content file, work or playlist. Thus, for example, multiple content segments can share a same (or duplicate) CLPI file, whether such content segments are for a same content work (e.g., movie title), different content works (e.g., different movie titles) or for content segments of different quality (as described with an embodiment of FIG. 2). In one implementation, a set of X (e.g. 20) CLPI files are generated and maintained for an entire content library that includes, for example, movie titles or various items of supplemental content (e.g. trailers, etc.). Thus, content segments of, for example, a new release can be conformed to an existing CLPI file.

In one embodiment, the Blu-ray player identifies and uses a standard CLPI file 112 from a local source (e.g., Blu-ray Disc), in connection with playing back content from the local source. The same CLPI file 112 can be used to receive and process streaming content to enhance, augment or supplement the playback of content from the local source. Thus, the local and network content can be processed using the same standard CLPI file 112. In such embodiments, the local CLPI file 112 can be carried on the local source. Alternatively, the local media source (or device) can be identified to a network service which then transmits the standard CLPI file to the device for use in playing back content from both the local and network source concurrently. The network service can be the same as that used to perform encoding, chunking, muxing, conforming, compacting, encrypting and/or streaming.

Additionally, an embodiment provides for a standard CLPI file 112 to be predefined for use in connection with content segments 102 at different levels of quality. For example, a network service may implement functionality as described with an embodiment of FIG. 1, to communicate content segments 102 with same or duplicate CLPI files 112 to a Blu-ray player over a network. The use of standard CLPI files, as created and used by embodiments described herein, are in contrast to conventional approaches, which associate individual content segments with CLPI files that are specific to the particular content work or playlist (E.g., movie title). Thus, for example, in a conventional approach, the CLPI file associated with a particular content segment includes parameters that are specific to the particular work or playlist that the content segment comprises. In contrast, embodiments provide that the standard CLPI file 112 associated with a particular content segment is predefined independently of any content segment, work or playlist. Thus, the parameters specified in the CLPI file 112 are not set based on the content segment 102.

Rather, as described below, the content segment 102 that comprise the work or playlist are conformed to a standard CLPI file 112. Furthermore, the same CLPI file 112 may be used across multiple works or playlists. In one implementation, the content segments 102 may include padding packets, to enable multiple content segments to specify a same start/end time in the CLPI file.

Accordingly, embodiments provide for a conforming process 140 to be performed in order to associate a standard CLPI file 112 with one or more content segments 102. According to embodiments, the one or more content segments 102 are structured to conform to a set of parameters that are specified in the associated CLPI file 112. In the conforming process 140, the individual content segments 102 are structured to include characteristics that match the specific parameters identified by the associated CLPI file 112. The conforming process 140 can structure each of multiple content segments 102 to include conforming characteristics such as stream size, number of source packets, start/end time for the clip, and iframe locations within individual content segments 102.

In particular, the conforming process 140 can be implemented to accommodate timing parameters, such as start/end time and iframe locations, so as to match the parameters specified by the CLPI file(s) 112 in use. For example, the end time of the segment 102 is set first to ensure the segment stops at the appropriate instance. In order to conform to the iframe requirements mandated by the CLPI file 112, the conforming process inserts padding packets 134 as needed in the segments 110 to ensure the iframe locations of the segments align with the positions required by parameters of the CLPI file 112.

In an embodiment, a compacting process 150 is implemented to remove padding packets 134 from the individual segments 110. Information about the location of the padding packets 134 can be maintained separately in a map file 142.

As an alternative or variation, the conforming process 140 may be implemented to insert padding in locations where padding is to be inserted and maintains the information in the map file 142.

An encryption process 160 is performed in which conformed segments 102, without padding, are then encrypted and delivered to a client 162 (e.g., Blu-ray player). In one implementation, the map file 142 is delivered independently and/or separately from the encryption process 160. According to some embodiments, a content delivery network may be used to deliver the segments. The client 162 receives, from the service, individual segments 110, the map file 142, and a playlist file 155. The map file 142 is used to insert (or re-insert) padding packets 134 into the individual segments 110 at the locations set forth in the map file 142. The segments 110 are then played back in the sequence set forth in the playlist 155. Among other benefits, the conformance of the delivered segments 110 to a predefined standard CLPI file 112 enables the Blu-ray player 162 to swap out clips from different sources while playing back content, and without having to perform a soft reboot or VFS update. For example, the Blu-ray player can use the standard CLPI file 112 to (i) playback content from a local source, such as a Blu-ray Disc, using the standard CLPI file 112, (ii) supplement, augment, or enhance the local content with conforming (to the standard CLPI file 112) content segments that are received from a network source, without need for a soft-reboot or VFS update. As such, the clips delivered from the network to the Blu-ray player 162 may be replacements or swaps for other clips that were in use on the player. Furthermore, the standard CLPI file 112 can be used for content works or play-lists that originate from the local source, and which are supplemented from the network source.

FIG. 2 illustrates a process for varying the bit-rate of playback on a Blu-ray player for content originating from a network, according to an embodiment. A process such as described by an embodiment of FIG. 2 may be implemented on a client, such as a dedicated Blu-ray device, or computing device (e.g., personal computer or gaming console) that operates a Blu-ray player.

In FIG. 2, multiple content items 210a, 210b, 210c of a common work (e.g. movie title, television program, music video, etc.) are segmented at different levels of quality. Each content item 210 is comprised of segments 212a, 212b, 212c which represent a common unit of playback (as measured in playback time). But the segments 212 have different amounts of data, based on the quality level of the segment. Lower quality segments have less data and can be streamed to occupy lesser amounts of band-widths.

In one embodiment, the use of segments that conform to a pre-defined standard CLPI 112 (as described with an embodiment of FIG. 1) enable variable bit rate playback to be implemented on the player 162. The variable bit rate playback enables the client to control the data quality of the streaming content it receives from, for example a network service (e.g., such as described with an embodiment of FIG. 1). As described with other embodiments, the player 162 can playback streaming content from a network service in response to, and/or in connection with operation of physical media (e.g., Blu-ray Disc).

According to embodiments, the use of standard CLPI files 112 ensure that each of the content segment 212a, 212b, 212c have the same timing related parameters. In particular, embodiments enable, or otherwise provide for the player 162 to use padding packets in frames to ensure that the streams have common end times and instances of iframes. The streams with lower quality have greater amounts of padding (or padded frames). The player 162 is able to transition between segments of different quality levels because the segments are structured to conform to the pre-defined standard CLPI file 112, so as to have, for example, common end times and iframes. This allows the player 162 to implement variable bit rate streaming playback.

According to embodiments, the player 162 determines the bandwidth for which it can receive files. In one embodiment, the player 162 measures network quality by identifying the rate of incoming segments. The player can then determine whether it can receive streaming media at a higher data quality. If the player 162 can receive the streaming media at the higher quality (e.g., as a result of network bandwidth), the player can send the communication to the network service to receive the higher quality content segments. Likewise, if the player 162 needs to reduce the data quality of the content segments, the player can communicate with the service to reduce the quality of the content segments. The communications sent from the player to the network service can be based on the player's determination as to, for example, available bandwidth or other factors which can affect the amount of data that can be received or processed on the player 162.

In an embodiment, the variations in the amount of data contained in the content segments 212a, 212b, 212c do not affect the timing parameters as between the content segments representing the same unit of content. The content segments 212a, 212b, 212c are structured (e.g., with padding packets 134) to conform to the set of parameters that are specified by the predefined standard CLPI file 112.

In an embodiment, processes such as described with FIG. 1 and FIG. 2 may be implemented on or using a computer system. FIG. 3 is a block diagram that illustrates a computer system 300 upon which embodiments such as described may be implemented. With regard to FIG. 1, a server, or combination of servers can be used to implement a network service that streams data to Blu-ray players, as described. The server(s) can be implemented using a computing system such as described with an embodiment of FIG. 3.

Similarly, various computing devices and environments can operate Blu-ray players, as described with embodiments of FIG. 1 or FIG. 2. Such computing devices can also be implemented using a computer system such as described herein.

In an embodiment, computer system 300 includes processor 304, main memory 306, ROM 308, storage device 310, and communication interface 318. Computer system 300 includes at least one processor 304 for processing information. Computer system 300 also includes a main memory 306, such as a random access memory (RAM) or other dynamic storage device, for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device for storing static information and instructions for processor 304. A storage device 310, such as a magnetic disk or optical disk, is provided for storing information and instructions.

Computer system 300 may be coupled to a display 312, such as a cathode ray tube (CRT), a LCD monitor, and a television set, for displaying information to a user. An input device 314, including alphanumeric and other keys, is coupled to computer system 300 for communicating information and command selections to processor 304. Other non-limiting, illustrative examples of input device 314 include a mouse, a trackball, or cursor direction keys for communicating direction information and command selections to processor 304 and for controlling cursor movement on display 312. While only one input device 314 is depicted in FIG. 3, embodiments of the invention may include any number of input devices 314 coupled to computer system 300.

Embodiments of the invention are related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any medium that participates in storing instructions which may be provided to processor 304 for execution. Such a medium may take many forms, including but not limited to, non-volatile media and volatile media. Non-volatile media includes, for example, optical or magnetic disks, such as storage device 310. Volatile media includes dynamic memory, such as main memory 306.

Examples of machine-readable media include, for example, a floppy disk, a flexible disk, hard disk, magnetic tape, or any other magnetic medium, a CD-ROM, any other optical medium (e.g., Blu-ray Disc), a RAM, a PROM, and EPROM, a FLASH-EPROM, any other memory chip or cartridge, or any other medium from which a computer can read.

Various forms of machine readable media may be involved in carrying one or more sequences of one or more instructions to processor 304 for execution. For example, the instructions may initially be carried on a magnetic disk of a remote computer. The remote computer can load the instructions into its dynamic memory and send the instructions over a network link 320 to computer system 300.

Communication interface 318 provides a two-way data communication coupling to a network link 320 that is connected to a local network. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through a local network to a host computer or to data equipment operated by an Internet Service Provider (ISP).

Computer system 300 can send messages and receive data, including program code, through the network(s), network link 320 and communication interface 318. For example, a server might transmit a requested code for an application program through the Internet, a local ISP, a local network, subsequently to communication interface 318. The received code may be executed by processor 304 as it is received, and/or stored in storage device 310, or other non-volatile storage for later execution.

Although illustrative embodiments have been described in detail herein with reference to the accompanying drawings, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for streaming content to a Blu-ray player, the method being implemented by one or more processors and comprising:
(a) providing a standard Clip Information (“CLPI”) file, the CLPI file specifying a set of parameters that are determined independent of any particular set of content segments;
(b) structuring a plurality of content segments to individually conform to the standard CLPI file, including to the set of parameters;
(c) streaming the plurality of content segments to the Blu-ray player using the standard CLPI file.

2. The method of claim 1, wherein set of parameters identify start/end times and iframe locations within individual content segments in the plurality of content segments.

3. The method of claim 1, further comprising playing back the plurality of content segments as a playlist or content work using the standard CLPI file.

4. The method of claim 1, wherein (b) includes inserting padding packets into individual content segments in the plurality of content segments prior to performing (c).

5. The method of claim 4, wherein the padding packets conform the individual content segments to provide one or more characteristics that are determined by a parameter specified in standard CLPI file.

6. The method of claim 5, wherein the one or more characteristics provide for a start time, an end time, and a location of an iframe.

7. The method of claim 1, further comprising enabling the padding packets to be removed for playback.

8. The method of claim 1, further comprising structuring a content work into a plurality of content segments, wherein steps (a) through (c) are performed for each of the plurality of content segments.

9. The method of claim 1, wherein steps (a) through (c) are performed on a service that streams content to a Blu-ray player, in connection with the Blue-ray player playing back a content from a local source.

10. The method of claim 1, further comprising associating the standard CLPI file with content segments from different content works.

11. The method of claim 1, wherein the CLPI file is provided on a Blu-ray disc that is locally accessed by the Blu-ray player, and wherein (b) is performed at a network site from which the plurality of content segments are streamed in (c).

12. The method of claim 1, wherein (a) through (c) are performed at a network site.

13. A method for operating a Blu-ray player, the method being implemented by one or more processors and comprising:
(a) playing back streaming content received from a network service on a Blu-ray player, the streaming content being received at a first quality level;
(b) while playing back the streaming content, determining, on the Blue-ray player, an available bandwidth on a network connection on which the streaming content is received;
(c) based on the determined available bandwidth, communicating with the network service to receive and playback the streaming content at a second quality level.

14. The method of claim 13, wherein (a) includes receiving a plurality of content segments of the first quality level, each of the plurality of content segments being associated with a same standard Clip Information (“CLPI”) file, and using the same standard CLPI file to playback each of the plurality of content segments at the first quality level.

15. The method of claim 14, further comprising receiving the plurality of content segments of the second quality level, each of the plurality of content segments being associated with the same standard CLPI file, and using the same standard CLPI file to playback each of the plurality of content segments at the second quality level.

16. The method of claim 15, wherein the same standard CLPI file specifies a same set of parameters, including a particular start and end time, for each of the plurality of content segments of the first and second quality level.

17. The method of claim 15, further comprising removing padding packets from individual content segments of each of the plurality of content segments of the first and second quality level.

18. The method of claim 14, (a) through (c) are performed while the Blu-ray player is using a local Blu-ray disc.

19. A computer-readable medium that stores instructions for streaming content to a Blu-ray player, the instructions being executable by one or more processors for performing operations comprising:
(a) generating a standard Clip Information (“CLPI”) file content segment, the CLPI file specifying a set of parameters that are independent of any particular set of content segments;
(b) structuring a content segment to conform to the standard CLPI file, including to the set of parameters; and
(c) streaming the content segment to the Blu-ray player using the standard CLPI file.

20. A Blu-ray player comprising:
one or more processors to:
(a) play back streaming content received from a network service on a Blu-ray player, the streaming content being received at a first quality level;
(b) while playing back the streaming content, determine, on the Blue-ray player, an available bandwidth on a network connection on which the streaming content is received;
(c) based on the determined available bandwidth, communicate with the network service to receive and playback the streaming content at a second quality level.
